(19) United States
(12) Patent Application Publication
(10) Pub. No.: US 2005/0039563 A1
(43) Pub. Date: Feb. 24, 2005

(54) Brake operating apparatus

(76) Inventors: Haruo Arakawa, Toyota-shi (JP); Takahisa Yokoyama, Anjo-shi (JP); Takayuki Takeshita, Anjo-shi (JP)

Correspondence Address: BURNS DOANE SWECKER & MATHIS L L P, POST OFFICE BOX 1404, ALEXANDRIA, VA, 22313-1404, US

(21) Appl. No.: 10/911,657

(22) Filed: Aug. 5, 2004

(30) Foreign Application Priority Data
Aug. 21, 2003 (JP) 2003-297377

(51) Int. Cl. G05G 1/14

(52) U.S. Cl. 74/512

(57) ABSTRACT

A brake operating apparatus includes a brake pedal lever pivotally attached to a bracket, an output member provided between the brake pedal lever and a brake actuating device, and a lever-ratio-changing mechanism provided between the brake pedal lever and the output member. The lever-ratio-changing mechanism includes a link member provided on one side of the brake pedal lever and rotatably attached thereto via a support shaft. The link member is linked to a rear end portion of the output member via a link shaft provided on the link member at a position offset radially from the support shaft by a predetermined amount. An interlocking mechanism is provided on the side of the brake pedal lever and between the stationary member and the link member. The interlocking mechanism causes the link member to rotate about the support shaft in accordance with pivotal movement of the brake pedal lever.

### BACKGROUND OF THE INVENTION

1. Field of the Invention

The present invention relates to a brake operating apparatus used in a vehicle, and more particularly to a brake operating apparatus having a lever-ratio-changing mechanism for changing a lever ratio (the ratio between an output force and an input force) in accordance with pivotal movement of a brake pedal lever.

2. Description of the Related Art

A brake operating apparatus of such a type is disclosed in, for example, Japanese Patent No. 2848078. The brake operating apparatus has a lever-ratio-changing mechanism configured as follows: an intermediate lever is pivotally attached, via a support shaft, to a bracket (a stationary member fixed to a vehicle body), which supports a brake pedal lever such that the brake pedal lever is pivotally movable; one end portion of the intermediate lever is linked to a rear end portion of an output member via a pin (a link shaft); and the other end portion of the intermediate lever is in continuous contact with a pivotal end portion (an output portion) of the brake pedal lever.

The above conventional brake operating apparatus requires provision of the intermediate lever between the pivotal end portion of the brake pedal lever and the rear end portion of the output member. The intermediate lever occupies a space in terms of the front-rear and height directions of a vehicle. Thus, as compared with a basic brake operating apparatus not having a lever-ratio-changing mechanism, the conventional brake operating apparatus requires greater mounting space in terms of the front-rear and height directions of a vehicle.

### SUMMARY OF THE INVENTION

In view of the foregoing, an object of the present invention is to provide a brake operating apparatus having a lever-ratio-changing mechanism and capable of being mounted in a space, in terms of the front-rear and height directions of a vehicle, equivalent to a space required for mounting a basic brake operating apparatus not having a lever-ratio-changing mechanism.

To achieve the above object, the present invention provides a brake operating apparatus comprising a brake pedal lever pivotally attached, via a pivot shaft, to a stationary member fixed to a vehicle body, and being pivotally moved by means of an input force; an output member, a front end portion of the output member being connected to a brake actuating device, a rear end portion of the output member being linked to the brake pedal lever, and the output member being movable in an actuating direction of the brake actuating device; and a lever-ratio-changing mechanism provided between the brake pedal lever and the output member and adapted to change a lever ratio in accordance with pivotal movement of the brake pedal lever. The lever-ratio-changing mechanism comprises a link member and an interlocking mechanism. The link member is provided on one side of the brake pedal lever and rotatably attached thereto at a predetermined position via a support shaft. The link member is pivotally linked to a rear end portion of the output member via a link shaft, which is provided on the link member at a position offset radially from the support shaft by a predetermined amount. The interlocking mechanism is provided on the side of the brake pedal lever and between the stationary member and the link member. The interlocking mechanism causes the link member to rotate about the support shaft in accordance with pivotal movement of the brake pedal lever.

Preferably, the interlocking mechanism comprises a stationary teeth section formed on the stationary member along a direction of pivotal movement of the brake pedal lever; and a rotative teeth section formed on the link member and constantly engaged with the stationary teeth section. Alternatively, the interlocking mechanism comprises a first engagement section formed continuously and longitudinally on an intermediate portion of a belt-like member supported at opposite ends by the stationary member; and a second engagement section formed on a rotative portion of the link member and engaged with the first engagement section without slippage.

In the brake operating apparatus of the present invention, the lever-ratio-changing mechanism comprises the link member for linking the brake pedal lever with a rear end portion of the output member, and the interlocking mechanism for rotating the link member in accordance with pivotal movement of the brake pedal lever, wherein both the link member and the interlocking mechanism are disposed on the same side of the brake pedal lever. Thus, even though the lever-ratio-changing mechanism is provided, the brake operating apparatus of the present invention can be mounted in a space equivalent, in terms of the front-rear and height directions of a vehicle, to a space required for mounting of a basic brake operating apparatus not having a lever-ratio-changing mechanism, thereby enhancing mountability on a vehicle.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a side view schematically showing an embodiment of a brake operating apparatus according to the present invention;

FIG. 2 is a side view for explaining the action of the brake operating apparatus of FIG. 1;

FIG. 3 is a schematic diagram defining dimensions and angles used to obtain the lever ratio of the brake operating apparatus of FIGS. 1 and 2;

FIG. 4 is a characteristic diagram showing the relationship between the pedal stroke and the lever ratio of the brake operating apparatus of FIGS. 1 and 2;

FIG. 5 is a diagram showing two lever-ratio characteristic curves (representing a characteristic of a change in a lever ratio and in an output force in relation to an input force to a pedal), which differ in the initial lever ratio (phase), the final lever ratio (period), and the quantity of a change (amplitude) in the lever ratio, together with a lever-ratio characteristic curve representing the case of a fixed lever ratio;

FIG. 6 is a diagram showing two lever-ratio characteristic curves (representing a characteristic of a change in an output force and in an input force to a pedal in relation to a pedal stroke), which differ in the initial lever ratio (phase), the final lever ratio (period), and the quantity of a change (amplitude) in the lever ratio, together with a lever-ratio characteristic curve representing the case of a fixed lever ratio;

FIG. 7 is a side view schematically showing another embodiment of a brake operating apparatus according to the present invention; and

FIG. 8 is a side view schematically showing a basic brake operating apparatus not having a lever-ratio-changing mechanism.

### DESCRIPTION OF THE PREFERRED EMBODIMENTS

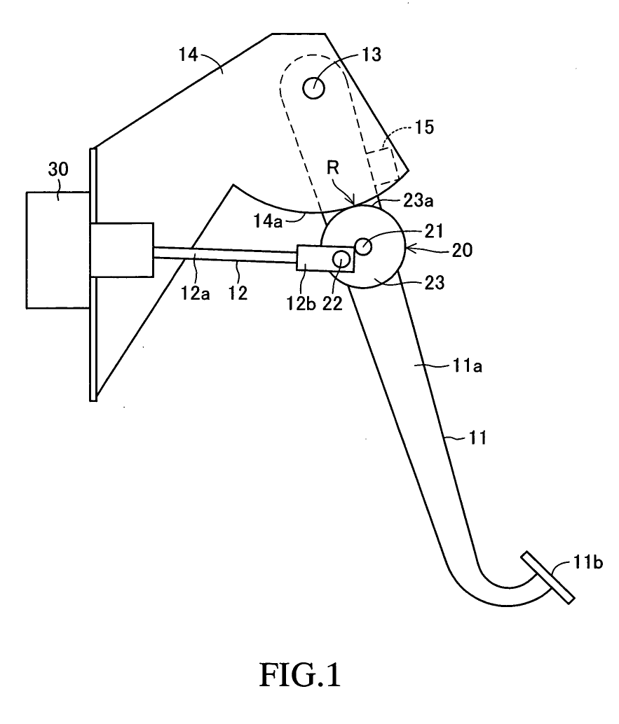

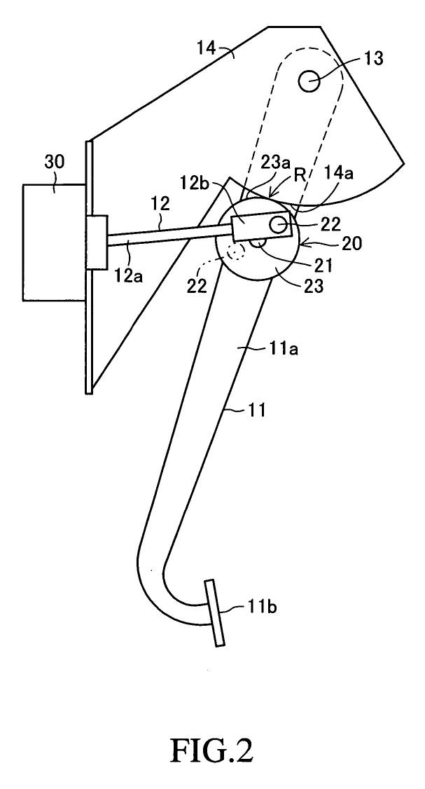

Embodiments of the present invention will next be described in detail with reference to the drawings. FIGS. 1 and 2 schematically show an embodiment of a brake operating apparatus according to the present invention. The brake operating apparatus includes a brake pedal lever 11, an output member 12, and a lever-ratio-changing mechanism 20 for changing a lever ratio (the ratio, P/F, between an output force P from the brake pedal lever 11 and an input force F to the brake pedal lever 11) as the brake pedal lever 11 is moved pivotally.

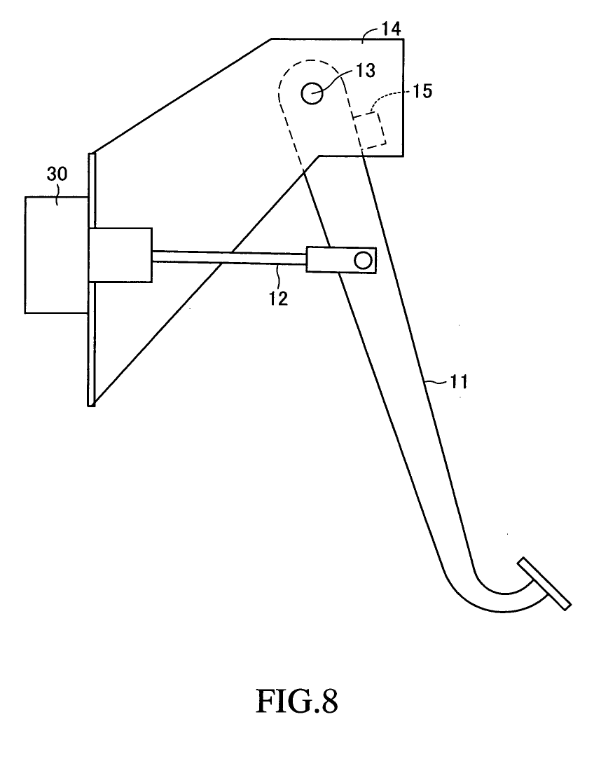

As in the case of a brake pedal lever 11 of a basic brake operating apparatus shown in FIG. 8, which does not have the lever-ratio-changing mechanism 20, the brake pedal lever 11 of the present embodiment includes a lever element 11a and a pedal element 11b and is pivotally attached, at an upper end portion of the lever element 11a, to a bracket 14 via a pivot shaft 13. The bracket 14 serves as a stationary member fixedly attached to a vehicle body. Notably, an unillustrated spring urges the brake pedal lever 11 to move toward an original position (a position where the brake pedal lever abuts a stopper 15 provided on the bracket 14) of FIG. 1.

As in the case of the output member 12 of the break operating apparatus shown in FIG. 8, the output member 12 includes a push rod 12a and a yoke 12b. A front end portion of the push rod 12a is connected to a brake actuating device (e.g., a brake booster) 30, and a rear end portion of the push rod 12a is linked to the brake pedal lever 11 via the yoke 12b. When the brake pedal lever 11 pivotally moves upon application of an input force (a step-on force) F to the pedal element 11b, the output member 12 moves in an actuating direction (towards the front of the vehicle, or leftward in FIGS. 1 and 2) of the brake actuating device 30.

The lever-ratio-changing mechanism 20 includes a disklike link member 23 and an interlocking mechanism R. The link member 23 is disposed on one side of the brake pedal lever 11, and is rotatably attached to the brake pedal lever 11 at a predetermined position via a support shaft 21. The link member 23 is pivotally linked to a rear end portion of the yoke 12b via a link shaft 22, which is provided on the link member 23 at a position offset radially from the support shaft 21 by a predetermined amount (D). The interlocking mechanism R is provided on one side of the brake pedal lever 11 and between the bracket 14 and the link member 23. The interlocking mechanism R causes the link member 23 to rotate about the support shaft 21 as the brake pedal lever 11 is moved pivotally.

The interlocking mechanism R includes a stationary teeth section (whose details are unillustrated) 14a formed on the bracket 14 and a rotative teeth section (whose details are unillustrated) 23a formed on the outer circumference of the link member 23. The stationary teeth section 14a includes a plurality of stationary teeth (not shown), which are continuously formed on the bracket 14 along the direction of pivotal movement of the brake pedal lever 11 and in an arcuate path about the pivot shaft 13. The rotative teeth section 23a includes a plurality of rotative teeth (not shown), which are constantly engaged with the stationary teeth section 14a and are formed in an arcuate path about the support shaft 21.

In the interlocking mechanism R, when the brake pedal lever 11 is pivotally moved from a condition of FIG. 1 (at the original position and in a brake-released standby condition) to a condition of FIG. 2 (a braking condition), the engagement position between the stationary teeth section 14a and the rotative teeth section 23a moves leftward in FIGS. 1 and 2. As a result, the link member 23 rotates, on the brake pedal lever 11, clockwise (in FIGS. 1 and 2) about the support shaft 21.

In the thus-configured embodiment, when the input force F is applied to the pedal element 11b of the brake pedal lever 11, the brake pedal lever 11 is pivotally moved from the condition of FIG. 1 to the condition of FIG. 2. As a result, while rotating, on the brake pedal lever 11, clockwise (in FIGS. 1 and 2) about the support shaft 21, the link member 23 presses and moves the output member 12 leftward (in FIGS. 1 and 2). Thus, the brake actuating device 30 is activated.

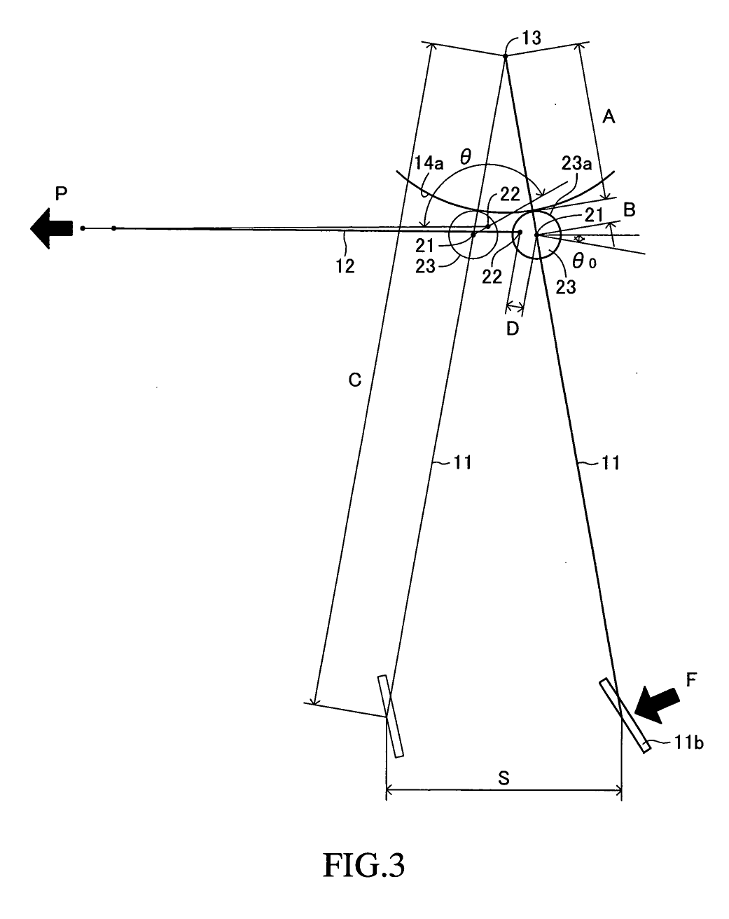

As the brake pedal lever 11 is moved pivotally from the condition of FIG. 1 to the condition of FIG. 2, the link member 23 rotates, on the brake pedal lever 11, clockwise (in FIGS. 1 and 2) about the support shaft 21. When values A, B, C, D, and θ₀ are defined as shown in FIG. 3, Eq. (1) shown below represents the relationship among the values, a pedal stroke S, and a rotational angle θ of the link member 23 (the angle between an extension line of the output member 12 and a line connecting the support shaft 21 and the link shaft 22). Eq. (2) shown below represents the relationship between an input force F to the pedal element 11b and an output force P from the output member 12.

$$\begin{matrix}θ = \frac{1}{C \times ( 1 + A / B )} \times S + {θ}_{0} & ( 1 ) \\ P = \frac{C}{\{ 1 - ( D / B ) \times sin θ \} ( A + B )} \times F & ( 2 )\end{matrix}$$

where, as shown in FIG. 3, A is the distance between the center of the pivot shaft 13 and the position of engagement between the stationary teeth section 14a and the rotative teeth section 23a; B is the distance between the center of the support shaft 21 and the position of engagement between the stationary teeth section 14a and the rotative teeth section 23a; C is the distance between the center of the pivot shaft 13 and the position where an input force is applied (a lever length); D is the distance (an offset) between the center of the support shaft 21 and the center of the link shaft 22; and θ₀ is an initial rotational angle of the link member 23. These are all set values (fixed values).

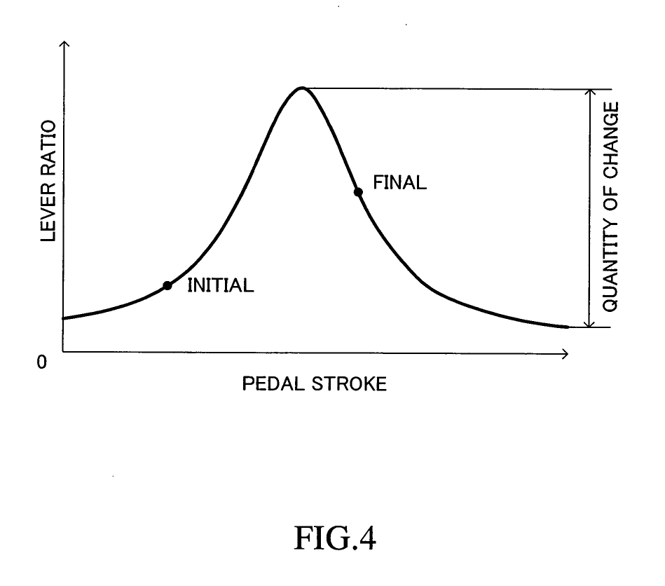

In the above Eq. (2), the coefficient for the input force F is a lever ratio. The lever ratio varies with the pedal stroke S as shown in FIG. 4. The initial lever ratio, the final lever ratio, and the quantity of a change in the lever ratio shown in FIG. 4 can be freely set by means of modifying merely the ratio between A and B, the ratio between B and D, or the initial rotational angle θ₀ in FIG. 3, without any modification of, for example, the mounting position of or the path swept by the brake pedal lever 11 or the mounting position of the brake actuating device 30.

Generally, at the initial stage of starting operating the brake pedal lever 11, a small lever ratio is preferred in order to reduce an idle stroke; and in the normal operating range (in the course of travel over a predetermined stroke), a large lever ratio is preferred in order to lessen an input force (an operating force) and to facilitate adjustment of an output force through adjustment of the pedal stroke. In an operational region beyond the normal operating range, a small lever ratio is again preferred in order to provide a sense of stiffness to a driver even though a small lever ratio is somewhat disadvantageous in terms of operating force.

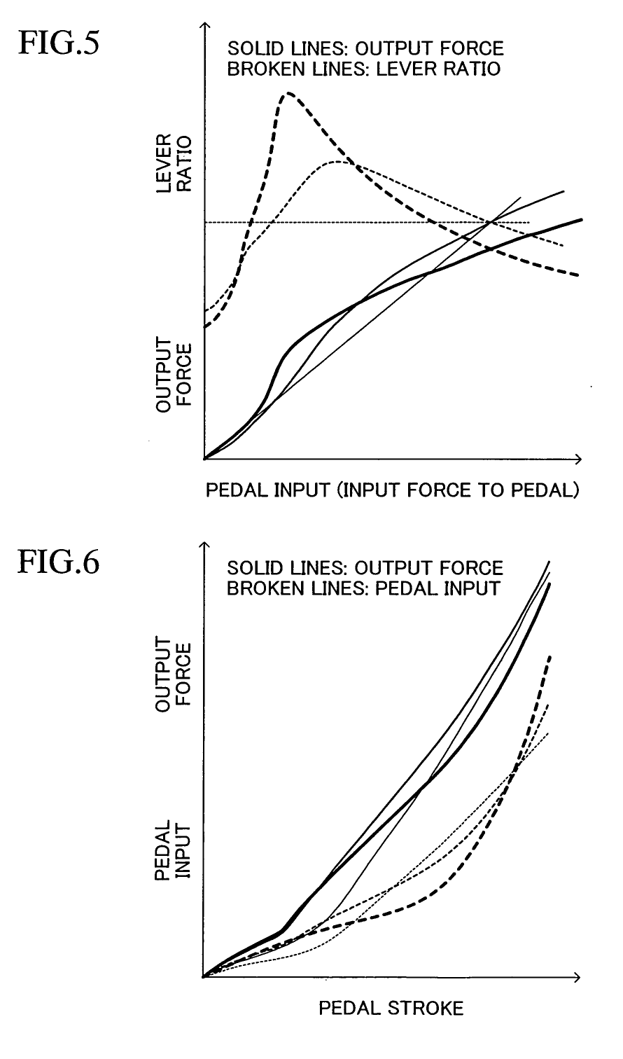

In any case, the lever ratio of the brake operating apparatus influences a reduction in operating force, the improvement of operational feeling, and the like. The present embodiment allows a user to freely set the initial lever ratio (phase), the final lever ratio (period), and the quantity of a change (amplitude) in the lever ratio appearing on a lever-ratio characteristic curve of FIG. 4 by modifying merely the ratio between A and B, the ratio between B and D, or the initial rotational angle θ⁰ shown in FIG. 3. Any lever-ratio characteristic curve; for example, a monotonically increasing lever-ratio characteristic curve or an increasing-and-then-decreasing lever-ratio characteristic curve, can be readily obtained for any purpose. FIGS. 5 and 6 show two lever-ratio characteristic curves, which differ in the initial lever ratio (phase), the final lever ratio (period), and the quantity of a change (amplitude) in the lever ratio, together with a lever-ratio characteristic curve (represented by a fine line) representing the case of a fixed lever ratio.

In the brake operating apparatus of the present embodiment, the lever-ratio-changing mechanism 20 includes the link member 23 for linking the brake pedal lever 11 with a rear end portion of the output member 12; and the interlocking mechanism R for rotating the link member 23 as the brake pedal lever 11 is pivotally moved. Also, both the link member 23 and the interlocking mechanism R are provided on one side of the brake pedal lever 11. Thus, even though the lever-ratio-changing mechanism 20 is provided, the brake operating apparatus of the present embodiment can be mounted in a space equivalent, in terms of the front-rear and height directions of a vehicle, to a space required for mounting of the basic brake operating apparatus shown in FIG. 8 not having the lever-ratio-changing mechanism 20. Thus, mountability on a vehicle can be enhanced.

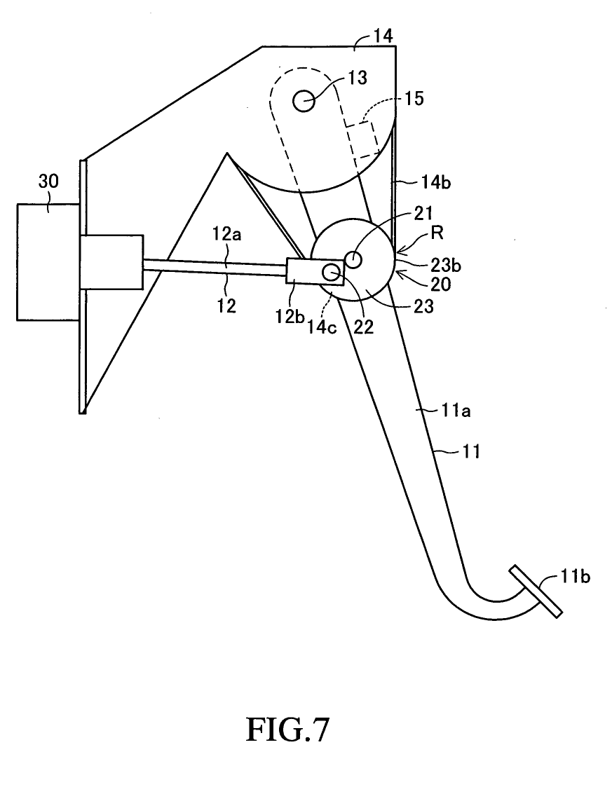

According to the above-described embodiment, the interlocking mechanism R, which is provided on one side of the brake pedal lever 11 and between the bracket 14 and the link member 23 and adapted to cause the link member 23 to rotate about the support shaft 21 as the brake pedal lever 11 is pivotally moved, is composed of the stationary teeth section 14a formed on the bracket 14 and the rotative teeth section 23a formed on the outer circumference of the link member 23. However, as schematically shown in FIG. 7, the interlocking mechanism R can be composed of a first engagement section (whose details are unillustrated) 14c formed on a belt-like member 14b, such as a chain or a timing belt, and a second engagement section 23b formed on the link member 23. The belt-like member 14b is supported at opposite ends by the bracket 14. The first engagement section 14c is formed continuously and longitudinally on an intermediate portion of the belt-like member 14b. The second engagement section 23b is formed on a rotative portion (an outer circumferential portion) of the link member 23. The first and second engagement sections 14c and 23b are engaged together without slippage.

In the above-described embodiment, the link member 23 assumes a disklike shape; the arcuate, rotative teeth section 23a is formed on the outer circumference of the link member 23; and the stationary teeth section 14a is formed on the bracket 14 and in an arcuate path about the pivot shaft 13. However, the present invention is not limited thereto. For example, the present invention may be embodied as follows: a rotative teeth section formed on a rotative portion of a link member assumes a noncircular shape (e.g., an elliptical shape), and a stationary teeth section to be engaged with the rotative teeth section is formed on the bracket.

According to the above description, the stationary teeth section 14a is formed on the bracket 14, which supports the brake pedal lever 11 such that the brake pedal lever 11 is pivotally movable. Alternatively, the belt-like member 14b is supported at opposite ends by the bracket 14. However, the present invention is not limited thereto. For example, the present invention may be embodied as follows: a stationary teeth section is formed on a stationary member other than the bracket 14, which pivotally supports the brake pedal lever 11. Alternatively, the invention may be embodied such that a belt-like member is supported at opposite ends by such a stationary member.

1. A brake operating apparatus comprising:
a brake pedal lever pivotally attached, via a pivot shaft, to a stationary member fixed to a vehicle body, and being pivotally moved by means of an input force;
an output member, a front end portion of the output member being connected to a brake actuating device, a rear end portion of the output member being linked to the brake pedal lever, and the output member being movable in an actuating direction of the brake actuating device; and
a lever-ratio-changing mechanism provided between the brake pedal lever and the output member and adapted to change a lever ratio in accordance with pivotal movement of the brake pedal lever;
wherein the lever-ratio-changing mechanism comprises a link member provided on one side of the brake pedal lever and rotatably attached thereto at a predetermined position via a support shaft, the link member being pivotally linked to a rear end portion of the output member via a link shaft provided on the link member at a position offset radially from the support shaft by a predetermined amount; and an interlocking mechanism provided on the side of the brake pedal lever and between the stationary member and the link member and causing the link member to rotate about the support shaft in accordance with pivotal movement of the brake pedal lever.

2. A brake operating apparatus according to claim 1, wherein the interlocking mechanism comprises a stationary teeth section formed on the stationary member along a direction of pivotal movement of the brake pedal lever; and a rotative teeth section formed on the link member and constantly engaged with the stationary teeth section.

3. A brake operating apparatus according to claim 1, wherein the interlocking mechanism comprises a first engagement section formed continuously and longitudinally on an intermediate portion of a belt-like member supported at opposite ends by the stationary member; and a second engagement section formed on a rotative portion of the link member and engaged with the first engagement section without slippage.
